(19) United States
(12) Patent Application Publication
(10) Pub. No.: US 2025/0003265 A1
(43) Pub. Date: Jan. 2, 2025

(54) MOTOR VEHICLE LOCK, IN PARTICULAR MOTOR VEHICLE DOOR LOCK

(71) Applicant: KIEKERT AKTIENGESELLSCHAFT, Heiligenhaus (DE)

(72) Inventors: Ömer INAN, Dorsten (DE); Peter SZEGENY, Engelskirchen (DE); Michael SCHOLZ, Essen (DE); Holger SCHIFFER, Meerbusch (DE); Andreas SCHMITZ, Velbert (DE); Thorsten BENDEL, Oberhausen (DE)

(73) Assignee: KIEKERT AKTIENGESELLSCHAFT, Heiligenhaus (DE)

(21) Appl. No.: 18/707,646

(22) PCT Filed: Nov. 10, 2022
(86) PCT No.: PCT/DE2022/100837

§ 371 Date: May 6, 2024

(30) Foreign Application Priority Data
Nov. 12, 2021 (DE) 10 2021 129 562.9

(51) Int. Cl. E05B 81/90; E05B 77/44; E05B 79/20

(52) U.S. Cl. CPC E05B 81/90; E05B 77/44; E05B 79/20

(57) ABSTRACT

A motor vehicle lock, in particular a motor vehicle door lock, equipped with a locking mechanism, which consists substantially of a rotary latch and a pawl, and additionally an electric opening drive for the locking mechanism and an emergency actuation element for a manual emergency opening of the locking mechanism. The emergency actuation element is arranged at least partly outside of a lock housing and acts on the locking mechanism by means of at least one transmission element for the purpose of an emergency opening process. According to the invention, the emergency actuation element has a cover cap which can be moved relative to the housing for actuating the transmission element. The cover cap additionally indicates the emergency actuation function thereof by virtue of the structural and/or optical design of the cover cap.

The invention relates to a motor vehicle lock, in particular a motor vehicle door lock, with a locking mechanism consisting substantially of a rotary latch and a pawl, further with an electric opening drive for the locking mechanism, and with an emergency actuation element for manual emergency opening of the locking mechanism, wherein the emergency actuation element is arranged at least partially outside a lock housing and operates by means of at least one transmission element on the locking mechanism for emergency opening.—The locking mechanism and the electric opening drive are largely located inside the lock housing. In contrast, the emergency actuation element is located at least partially outside said lock housing.

Nowadays, motor vehicle locks and particularly motor vehicle door locks are increasingly being equipped with an electric or electromotive drive at least for opening the locking mechanism, i.e., an electric opening drive, for reasons of convenience. For this reason, such motor vehicle locks are also referred to as electric locks. Consequently, the locking mechanism is not usually mechanically coupled to an external door handle, for example, in order to open the locking mechanism. Instead, actuation of the outside door handle leads to sensor actuation, which in turn is used via a control unit to actuate the electromotive drive or electric opening drive, which in turn opens the locking mechanism. For this purpose, the electromotive drive usually works on a triggering lever, either directly or indirectly. The triggering lever is usually used to lift the pawl from its latching engagement with the rotary latch when the locking mechanism is closed. This releases a locking bolt previously caught by the rotary latch. The corresponding motor vehicle door can be opened accordingly.

Such electric locks have proven themselves in practice because they require practically no force from the operator on the outside door handle and are also gentle and quiet in operation. However, their reliable operation requires that the electromotive drive or electric opening drive is supplied with sufficient electrical energy. The problem at this point is that the main energy source, which is usually located in the vehicle interior in the form of one or more batteries, is completely or partially discharged after a long period of inactivity or due to a defect. As a result, the motor vehicle lock in question can no longer be opened. In order to nevertheless enable emergency actuation, various approaches are being pursued in the prior art.

For example, DE 10 2019 127 109 A1 describes a motor vehicle lock with emergency actuation, in which the electromotive drive is equipped with an emergency energy source for emergency actuation of the lever chain. For this purpose, the lever chain has an emergency operating lever, which is inoperative in its normal position and is at least transferred to its operating position closing the emergency operating lever chain by means of the emergency operating drive. This is intended to provide a simple and cost-effective emergency actuation of the lever chain. However, the design effort required for the electromotive drive and the emergency energy source is not insignificant. In addition, malfunctions due to an at least partially discharged emergency power source cannot be completely ruled out.

In the further prior art according to WO 2019/076402 A1, a mechanical operating lever chain for emergency opening of the locking mechanism is implemented in a motor vehicle door lock. There is also a control element that directly or indirectly blocks the operating lever chain in normal operation and releases it for emergency opening. The control element is equipped with an electric motor with drive element. In addition, the control element can optionally block or release a flexible connecting element for coupling the operating lever chain to a handle. In this case, too, an additional electromotive drive in connection with an operating lever chain is ultimately required for the emergency operation, which corresponds to increased complexity in terms of design.

In the generic prior art according to US 201 1/01 07800 A1, an emergency actuation element is provided and realized as a lock cylinder outside a lock housing. A key inserted into the locking cylinder can be used for emergency opening of the locking mechanism as an alternative to an electromotive drive. For this purpose, the locking cylinder is coupled to the triggering lever via a connecting rod.

The prior art has generally and fundamentally proven itself when it comes to realizing an emergency operation of the locking mechanism, for example in the event of failure of the electromotive drive or a battery or main energy source of the motor vehicle. However, complex solutions with their own drive, operating lever chain and emergency power source are often propagated at this location. If the generic prior art uses a manually operated emergency actuation element outside the lock housing, the basic problem at this location is that moisture or dirt can penetrate the inside of the lock housing via the connecting rod as a transmission element and the associated forced opening. This may also cause damage to the electric opening drive.

This is partly due to the fact that such electromotive drives are often equipped with plastic components or gears for reasons of cost and weight. Dirt or moisture penetrating the lock housing at this point can cause abrasive damage to such plastic gear wheels and cause permanent functional impairment or even complete failure.

A further and substantial problem is the fact that the emergency actuation element for manual emergency opening of the locking mechanism is often protected or concealed. This applies both to installation on the exterior side of an associated motor vehicle door and when the emergency actuation element is present inside the relevant motor vehicle door. In fact, such an approach is usually preferred because the electric opening drive can fail following a crash, for example, and persons inside still want to leave the motor vehicle. In contrast, manual handles or the like can be provided for opening the relevant motor vehicle door from the outside, for example by arriving rescue personnel.

In the emergency described, the problem for persons inside the motor vehicle is often that the emergency actuation element is embedded in an interior door panel, but often cannot be found or is not easily accessible. This means that occupants involved in an accident cannot easily free themselves from the motor vehicle.

The same applies to arriving rescue personnel who, for example, are also faced with the problem of having to locate and operate the emergency actuation element inside after smashing a vehicle window. The invention as a whole seeks to remedy this.

The invention is based on the technical problem of further developing a motor vehicle lock and, in particular, a motor vehicle door lock in such a manner that, taking into account a simple, functional and cost-effective design, permanent functionality is ensured even over long time scales. In addition, safe location and proper operation of the emergency actuation element should be guaranteed.

To solve this technical problem, a generic motor vehicle lock is characterized in that the emergency actuation element has a cover cap for actuating the transmission element which can be moved relative to a housing, wherein the cover cap indicates its emergency actuation function by its structural and/or optical design.

In the context of the invention, first of all, the emergency actuation element is generally and fundamentally designed in two parts. In fact, the emergency actuation element consists substantially of the housing and the cover cap, which can be moved relative to the housing. The movability of the cover cap ensures accessibility and also loading of the transmission element, as explained in more detail below.

The further circumstance that the cover cap within the scope of the invention indicates the emergency actuation function by its structural and/or optical design is now of substantial importance. This means that the cover cap is designed in such a manner that it is directly brought into connection with the emergency actuation function, namely haptically and/or optically. The invention is based on the realization that the emergency actuation element is generally attached to the inside of a motor vehicle and in particular to an inner lining of an associated motor vehicle door or is recessed into the relevant inner lining. In most cases, the housing of the emergency actuation element is inserted into a corresponding cut-out in the inner door panel so that the cover cap remains the only element of the emergency actuation element visible from the outside.

In order to facilitate proper functioning and the location of the emergency actuation element, particularly in the event of an emergency or the crash described above, the cover cap is equipped with structural and/or optical features that make the emergency actuation function visible and/or can be detected haptically by an operator.

In fact, it is possible, for example, that the cover cap has at least one manual manipulation means such as a button, an eyelet or a handle as an indication of the emergency actuation function. The manual manipulation means in question is exposed in relation to the cover cap and can therefore be easily felt or picked up by an operator and can therefore be interpreted as an emergency operation or indicates this.

Alternatively or additionally, the cover cap can also be fitted with an optical indicator. This may be an imprint, color coding, etc. as an indication of the emergency actuation function. In principle, appropriate lighting etc. is also conceivable in order to be able to guarantee the information function even in poor lighting conditions.

A particularly advantageous variant is characterized by the fact that an electromotive drive is provided to actuate the cover cap. In this case, the procedure is such that the electromotive drive is activated in the event of a crash or afterwards, for example, and the cover cap is actuated with its help. This may involve the cover cap being swung open, removed from the housing or otherwise released so that the transmission element is visible to an operator and can be manipulated in order to use it to open the locking mechanism in an emergency. The invention is based on the realization that the said crash event can be detected by a sensory system, for example by means of a crash sensor, and that at this point in time there is (still) sufficient electrical energy available not only to actuate safety measures such as an airbag, side impact protection, etc., but also to actuate the electromotive drive for actuating the cover cap.

In this context, different variants for the specific design of the cover cap are conceivable. For example, the cover cap can be pivotally connected to the housing. However, it is also possible for the cover cap to be detachably latched to the housing. It is also possible to connect the transmission element to the cover cap in a detachable or non-detachable manner.

If the transmission element is detachably connected to the cover cap, an operator can easily grasp the transmission element after opening the cover cap and use it to open the locking mechanism in an emergency. However, it is also possible that the transmission element is non-detachably connected to the cover cap. In this case, a pivoting movement of the cover cap relative to the housing ensures that the locking mechanism is simultaneously opened in an emergency via the transmission element. Finally, it is also possible for the operator to pull on the cover cap, which has been released from the housing, together with the transmission element, for example, in order to ensure the desired emergency opening of the locking mechanism.

For this purpose, the transmission element is advantageously a flexible transmission element, for example in the form of a cable, a Bowden cable, etc. In addition, the design is usually such that the transmission element is connected to an operating lever for emergency opening of the motor vehicle lock. The operating lever is regularly mounted inside the lock housing. In order to ensure permanent and reliable operation, it has also proven useful if the operating lever is preferably guided to the outside via an opening in the lock housing. This opening can also be sealed so that, in contrast to the prior art, there is no risk of dirt or water entering the inside of the lock housing via the opening in question. This applies all the more in the event that the operating lever is mounted on the exterior side of the lock housing. In this case, too, the sealed opening may provide the connection between the operating lever and the locking mechanism.

As a result, a motor vehicle lock and particularly a motor vehicle door lock with a specially designed emergency actuation element is provided. This is regularly connected to the inside of a motor vehicle door. In principle, however, it is also possible to provide the emergency actuation element on the exterior side of the relevant motor vehicle door. The latter variant can be realized and also converted in a theft-proof manner, particularly if the electromotive drive is intended for actuating the cover cap. During normal operation, this drive may lock the cover cap so that it cannot be tampered with from the outside.

If, on the other hand, the main battery or vehicle battery fails, the electromotive drive ensures that the cover cap is swung open or ejected from the housing. However, if the emergency actuation element is located inside the associated motor vehicle or is connected to the inside of the relevant motor vehicle door, it is also possible to proceed in such a way that the electromotive drive always releases the cover cap during normal operation and does not biased it. Only when a crash occurs does the electromotive drive ensure that the cover cap is opened in relation to the housing so that the transmission element as a whole is accessible.

In connection with the further property of the emergency actuation element, according to which the cover cap indicates its emergency actuation function by its structural and/or optical design, not only is a permanent and functionally reliable operation of the emergency actuation element provided overall, but the location of the emergency actuation element in question is also significantly easier compared to previous embodiments.

In addition to previous embodiments, it is also possible to proceed in such a manner that the crash case acoustically indicates the emergency actuation function as an alternative or in addition to the actuation of the electromotive drive. This means that in addition to the haptic and/or visual indication on the cover cap, an acoustic indication of the emergency actuation element is also possible. This acoustic warning function means that in the event of a crash or immediately after a crash, an acoustic message is emitted via a radio or hands-free system in the motor vehicle in such a manner that the emergency actuation element, which is located, for example, on the driver's door in the area of an armrest or adjacent to the mirror adjustment or elsewhere, must be biased in order to open or emergency open the relevant motor vehicle door.

Here, as with the actuation of the electromotive drive for the cover cap, the invention is based on the knowledge that at the time the crash is detected, sufficient electrical energy is-still-available to actuate the electromotive drive to actuate the cover cap on the one hand and to provide the acoustic warning or information function described above on the other. Either way, emergency opening is significantly simplified compared to the prior art and achieves unprecedented accuracy. These are the main advantages.

In the following, the invention is explained in more detail with the aid of a drawing showing only an exemplary embodiment; in the figures:

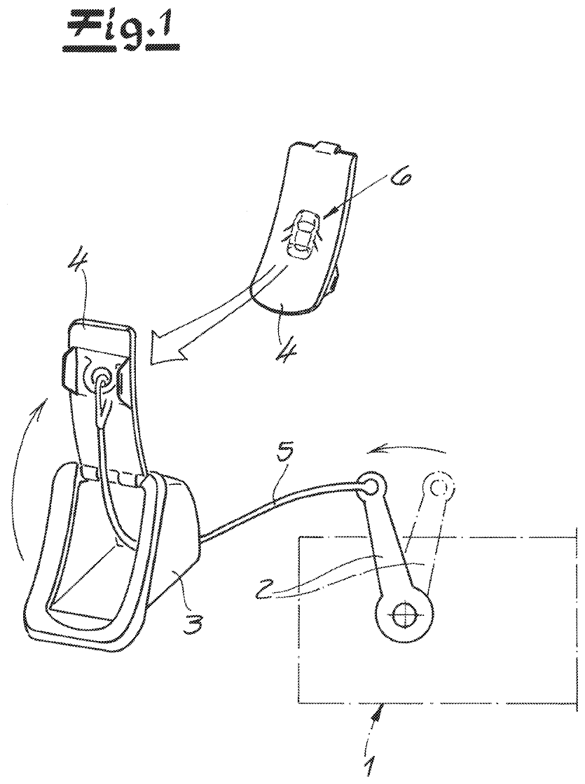

FIG. 1 shows a basic overview of the motor vehicle lock according to the invention and

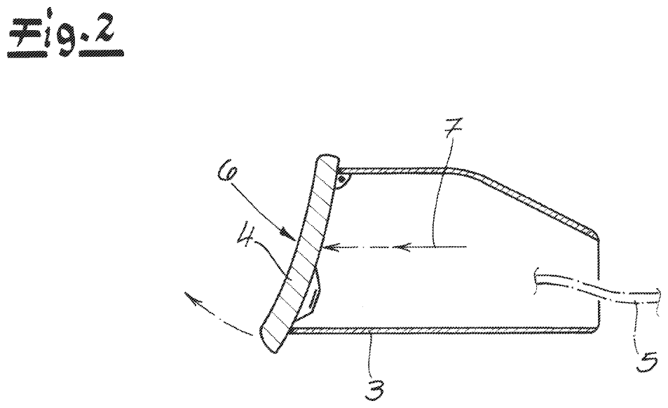

FIG. 2 shows a schematic section through the emergency actuation element.

The drawings show a motor vehicle latch which, according to the exemplary embodiment, is a motor vehicle door latch. In FIG. 1, only one lock housing 1 of the motor vehicle door lock is shown and reproduced purely schematically. The lock housing 1 contains a standard locking mechanism consisting of a rotary latch and a pawl, which is not shown. In addition, one can recognize an operating lever 2 mounted in the lock housing 1, with the help of which the motor vehicle lock or motor vehicle door lock can be opened in an emergency.

For this purpose, the operating lever 2 in question must be moved from its basic position shown in FIG. 1 with a dotted line to an actuating position shown as a solid line. This mechanical emergency opening corresponds to the fact that, according to the exemplary embodiment, the operating lever 2 performs a counterclockwise movement around its axis defined inside the lock housing 1. As a result, the operating lever 2 is able to lift the pawl as part of the locking mechanism consisting of rotary latch and pawl from its latching engagement with the rotary latch. As a result, the rotary latch opens spring-assisted and releases a previously trapped locking bolt. The correspondingly biased motor vehicle door, which is not expressly shown and equipped with the motor vehicle door lock described, can be opened or emergency-opened as a result.

Normally, the opening process of the locking mechanism in question, consisting substantially of rotary latch and pawl, is carried out by an electric motor. For this purpose, an electric opening drive for the locking mechanism is provided and realized, as described in detail in the prior art and shown in the drawings. Reference is made to DE 195 01 493 A1 by way of example only.

The described manual emergency opening of the locking mechanism and the actuation of the operating lever 2 takes place with the aid of an emergency actuation element 3, 4. For this purpose, the emergency actuation element 3, 4 is arranged at least partially outside the lock housing 1. In addition, at least one transmission element 5 is realized, with the help of which the emergency actuation element 3, 4 operates on the locking mechanism inside the lock housing 1 for emergency opening.

It can be seen that, according to the exemplary embodiment, the emergency actuation element 3, 4 on the one hand and the lock housing 1 on the other hand are designed to be structurally and locally separate from one another. Only transmission element 5 is responsible for the connection. The transmission element 5 is a flexible transmission element 5 which, according to the exemplary embodiment, is designed as a cable, plastic strap, Bowden cable, etc. In addition, the transmission element 5 is connected to the operating lever 2 on the one hand and a cover cap 4 as part of the emergency actuation element 3, 4 on the other. The connection between the cover cap 4 and the transmission element 5 may be detachable or firmly converted.

Overall, the design within the scope of the invention is such that the emergency actuation element 3, 4 has the cover cap 4, which can be moved relative to the housing 3, for actuating the transmission element 5. In addition, the cover cap 4 has a structural and/or visual design that indicates its emergency actuation function. For this purpose, the cover cap 4 can be equipped with a manual manipulation means such as a button, an eyelet or a handle as an indication of the emergency actuation function, although this is not represented in detail. Rather, according to the exemplary embodiment, the cover cap 4 has an optical indicator in the form of an imprint 6. In principle, color coding is also conceivable at this location as an alternative or in addition.

It is also within the scope of the invention to use an appropriately illuminated pictogram instead of the imprint 6. Either way, the imprint 6 or the optical indication means or alternatively the manual manipulation means ensures that in this manner the cover cap 4 has the desired indication of the emergency actuation function. This allows an operator to easily locate the cover cap 4.

In fact, the emergency actuation element 3, 4 is usually connected to the inside of a motor vehicle door. For this purpose, the emergency actuation element 3, 4 may be embedded with its housing 3 in a corresponding recess in an interior trim panel of the relevant motor vehicle door. In order to be able to identify the cover cap 4 correctly and accurately and to provide an indication of the emergency actuation function, imprint 6 is provided in the exemplary embodiment.

Furthermore, and in accordance with the sectional view in FIG. 2, an electromotive drive 7 can also be realized inside the housing 3 as a component of the emergency actuation element 3, 4, which is only schematically indicated as an arrow at this location. The cover cap 4 can be biased using the electromotive drive 7. In fact, in this case and also subsequently, it is conceivable that the cover cap 4 is pivotably connected to the housing 3 or is also detachably latched to the housing 3. Of course, combinations are also conceivable.

With the aid of the electromotive drive 7, the cover cap 4 can now be opened relative to the housing 3 or ejected relative to the housing 3, particularly in the event of a crash or immediately after a crash. As a result, in both cases the transmission element 5 becomes visible and can be manipulated by an operator. For this purpose, it is possible for the operator in question to grip the transmission element 5 directly, for example if it is detachably connected to the cover cap 4. However, it is also possible to press on the cover cap 4 and in this way ensure via the connected transmission element 5 that the operating lever 2 is pivoted counterclockwise for emergency opening in the manner described. As a result, the pawl is lifted from its latching engagement with the rotary latch so that the rotary latch then opens with spring support, releasing the locking bolt and thus also the motor vehicle door.

### LIST OF REFERENCE NUMBERS

Lock housing 1
Operating lever 2
Emergency actuation element 3,4
Housing 3
Cover cap 4
Transmission element 5
Imprint 6
Electromotive drive 7

1. A motor vehicle lock comprising:
a locking mechanism including a rotary latch and a pawl positioned within a lock housing,
an electric opening drive for operating the locking mechanism, the locking mechanism including at least one transmission element, and
an emergency actuation element for manual emergency opening of the locking mechanism, wherein the emergency actuation element is arranged at least partially outside the lock housing, and operates via the at least one transmission element on the locking mechanism for emergency opening,
wherein the emergency actuation element has an element housing and a cover cap movable relative to the element housing for actuating the transmission element, and wherein the cover cap includes an indicator that indicates an emergency actuation function to perform the emergency opening.

2. The motor vehicle lock according to claim 1, wherein the cover cap has a manual manipulation element, and the indicator corresponds to a position of the manual manipulation element as an indication of the emergency actuation function.

3. The motor vehicle lock according to claim 1, wherein the cover cap has a visual indicator that is an indication of the emergency actuation function.

4. The motor vehicle lock according to claim 1, wherein the emergency actuation element includes an electromotive drive for actuating the cover cap.

5. The motor vehicle lock according to claim 1, wherein the cover cap is pivotably connected to the element housing.

6. The motor vehicle lock according to claim 1, wherein the cover cap is detachably latched to the element housing.

7. The motor vehicle lock according to claim 1, wherein the transmission element is detachably connected to the cover cap.

8. The motor vehicle lock according to claim 1, further comprising an operating lever, wherein the transmission element is connected to the operating lever for emergency opening of the motor vehicle lock.

9. The motor vehicle lock according to claim 8, wherein the operating lever is mounted inside or on an exterior side of the lock housing and is guided to the outside of the lock housing via a sealed opening.

10. The motor vehicle lock according to claim 1, wherein the emergency actuation element is connected on an inside of a motor vehicle door.

11. The motor vehicle lock according to claim 2, wherein the manual manipulation element is at least one of a button, an eyelet, and a handle that is exposed in relation to the cover cap.

12. The motor vehicle lock according to claim 3, wherein the visual indicator is at least one of a print marking, a color marking, or an illuminated pictogram.

13. The motor vehicle lock according to claim 1, wherein emergency the transmission element is non-detachably connected to the cover cap.

14. The motor vehicle lock according to claim 1, wherein the indicator is a haptic indicator.

15. The motor vehicle lock according to claim 1, wherein the indicator is an acoustic indicator.

16. The motor vehicle lock according to claim 1, wherein the transmission element is a flexible cable and the emergency actuation element includes an operating lever that operates on the locking mechanism via the flexible cable.
